(19) United States
(12) Patent Application Publication
(10) Pub. No.: US 2008/0048432 A1
(43) Pub. Date: Feb. 28, 2008

(54) Printed matter inspection system, print inspection device, image forming device, inspection device, recording medium storing print inspection program, recording medium storing image forming program, and recording medium storing inspection program

(75) Inventor: Kentaro Tsuchiya, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 11/582,343

(22) Filed: Oct. 18, 2006

(30) Foreign Application Priority Data
Jun. 16, 2006 (JP) 2006-166797

(51) Int. Cl. B42D 15/00

(52) U.S. Cl. 283/67

(57) ABSTRACT

A printed matter inspection system, which includes: an image forming device including; a first identification information generation section that generates identification information for each printed matter based on user data, an identification information conversion section that converts the identification information into a printable identification image, a variable printing section that performs variable printing of the printed matter to which the identification image is added, using the user data, and a list printing section that prints out a list having the user data and the identification information both of which are associated with each other, and an inspection device including; an identification image read section that reads the identification image, and an inspection processing section that converts the identification image into identification information to inspect a printed matter.

### BACKGROUND

1. Technical Field

The present invention relates to a printed matter inspection system, a print inspection device, an image forming device, an inspection device, a recoding medium storing a print inspection program, a recoding medium storing an image forming program and a recoding medium storing an inspection program, and more particularly to the printed matter inspection system, the print inspection device, the image forming device, the inspection device, the recoding medium storing a print inspection program, the recoding medium storing an image forming program and the recoding medium storing an inspection program, for inspecting a printed matter by variable printing.

2. Related Art

For variable printing that overlays variable data on a prescribed portion of a form and prints out printed matters each having different information printed such as a business form, it is particularly demanded, in view of its property, to properly print out in an intended order without suffering from falsification of any variable data.

### SUMMARY

A printed matter inspection system according to an aspect of the invention, which includes: an image forming device including; a first identification information generation section that generates identification information for each printed matter based on user data, an identification information conversion section that converts the identification information into a printable identification image, a variable printing section that performs variable printing of the printed matter to which the identification image is added, using the user data, and a list printing section that prints out a list having the user data and the identification information both of which are associated with each other, and an inspection device including; an identification image read section that reads the identification image, and an inspection processing section that converts the identification image into identification information to inspect a printed matter.

### BRIEF DESCRIPTION OF THE DRAWINGS

An exemplary embodiment of the present invention will be described in detail based on the following figures, wherein:

FIG. 1 is a functional block diagram showing an example of a structure of a printed matter inspection system according to the present invention;

FIG. 2 is a flow chart showing an example of a processing flow when user data is registered in an image forming device and a list is printed out;

FIG. 3 is a flow chart showing an example of a processing flow when a printed matter is printed out;

FIG. 4 is a flow chart showing an example of a processing flow when a printed matter is inspected using identification information stored in an inspection device;

FIG. 5 is a flow chart showing an example of a processing flow when a printed matter is inspected using identification information described on a list;

FIG. 6 is a functional block diagram showing an example of a structure of a printed matter inspection system of the first exemplary embodiment;

FIG. 7 is a flow chart showing an example of a processing flow when user data is registered in an image forming device and a list is printed out; and

FIG. 8 is a flow chart showing an example of a processing flow when identification information is stored in an inspection device.

### DETAILED DESCRIPTION

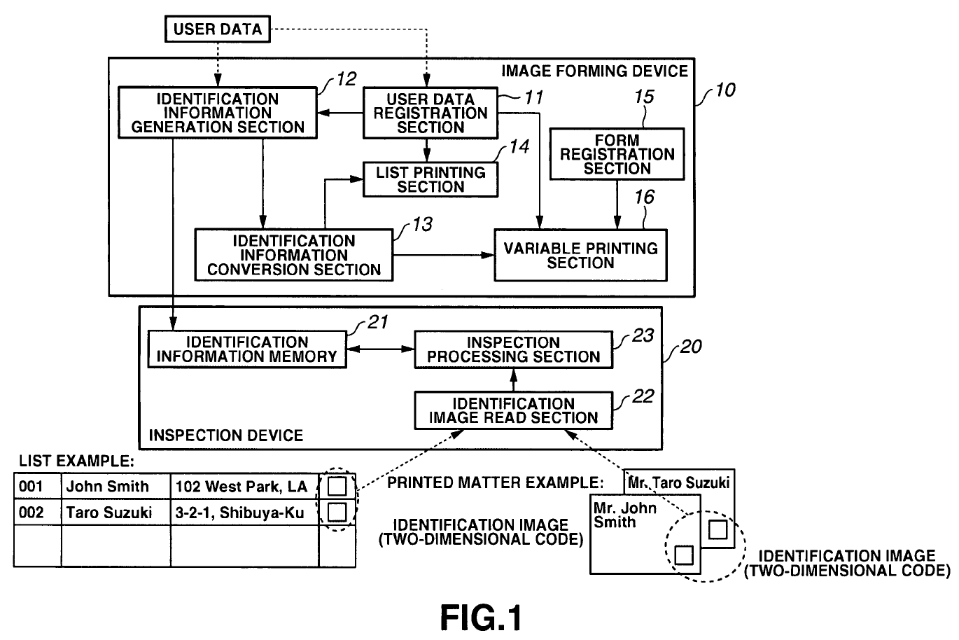

FIG. 1 is a functional block diagram showing an example of a structure of a printed matter inspection system of the invention.

As shown in FIG. 1, the printed matter inspection system has an image forming device 10 which executes variable printing to print out a printed matter and an inspection device 20 which inspects the printed matter, and connects them by means of a network such as LAN (Local Area Network) or the Internet, a local connection using a USB (Universal Serial Bus) cable or a serial cable, or another unshown arbitrary connection.

The image forming device 10 is provided with a user data registration section 11, an identification information generation section 12, an identification information conversion section 13, a list printing section 14, a form registration section 15, and a variable printing section 16.

The user data registration section 11 registers user data (variable data) which is overlaid on a form to execute overlay printing. Specifically, for example, the user data which is generated by an information-processing device (not shown) such as PC (Personal Computer) is registered by obtaining via a media reader for reading information from media such as a USB memory or a network.

As the user data, for example, any variable data such as variable data in CSV (Comma Separated Values) format which is formed of record rows and field strings can be used.

The identification information generation section 12 generates identification information capable of judging that the user data is falsified for each printed matter on the basis of the user data to be printed on the printed matter. Specifically, for example, a hash value is calculated based on the user data and is used as identification information.

The identification information conversion section 13 converts the identification information generated by the identification information generation section 12 into data (identification image) that can be printed on the printed matter. Specifically, for example, the hash value generated by the identification information generation section 12 is converted into a two-dimensional code such as a bar code or QR code™.

The list printing section 14 executes processing to print out a list showing user data and an identification image of the user data. Specifically, for example, a list having information indicating each printed matter and an identification image generated based on the user data of the printed matter, both of which are mutually associated, is generated, is transmitted to an image forming section (not shown) for printing an image on a medium such as paper, and is printed out.

The form registration section 15 registers a form to perform overlay printing with the user data overlaid on it. Specifically, for example, a form produced by an information-processing device (not shown) such as PC is obtained via a media reader or a network, and is registered.

The variable printing section 16 executes processing for printing out a printed matter. Specifically, for example, the user data, the form corresponding to the user data and an identification image of the user data are obtained, and the user data is overlaid on the form. Then, the identification image is added to a prescribed portion to generate print data, and the print data is transmitted to the image forming section (not shown) to execute the overlay printing.

At this time, it is desirable that a hash value of the user data is recalculated for each printed matter to regenerate identification information, and an identification image based on the regenerated identification information is added to the printed matter.

The user data registration section 11, the identification information generation section 12, the identification information conversion section 13, the list printing section 14, the form registration section 15 and the variable printing section 16 are parts to be realized by a program or the like installed in a computer for controlling the image forming device.

With the above-described configuration, the image forming device generates identification information based on the user data, and converts the identification information into a printable identification image. And, a list having the information indicating the printed matter and the identification image of the printed matter, both of which are mutually associated, is printed out. When an instruction to print out the printed matter is given, the user data is overlaid onto a prescribed portion of the form, and the identification image is added to generate print data, and the printed matter having the identification image added is printed out.

The inspection device 20 is provided with an identification information memory 21, an identification image read section 22, and an inspection processing section 23.

The identification information memory 21 stores identification information. Specifically, for example, in a case where the identification information is a hash value, the hash value is stored as the identification information.

The identification information can be obtained by using any method, such as a method of receiving from an image forming device through a network, a method of reading from a medium on which identification information is recorded by using a media reader, or the like.

The identification image read section 22 reads an identification image. Specifically, for example, in a case where the identification image is a two-dimensional code, the identification image read section 22 is a device capable of reading an identification image, such as a bar code reader for a two-dimensional code, and reads the identification image added to a list or a printed matter.

The inspection processing section 23 converts the identification image added to the printed matter into identification information, and inspects the printed matter according to the identification information. Specifically, for example, it is judged whether or not the identification information obtained from the identification image of the printed matter agrees with the identification information stored in the identification information memory 21. If both of the identification information agree, “OK (not falsified)” is shown on UI (User Interface) (not shown), but if they do not agree, “NG (falsified)” is shown to notify the inspected result. When an inspection is performed according to the list, the identification image attached to the list and the identification image attached to the printed matter are read alternately to judge whether or not both of the identification information agrees, and then the inspected result is notified.

The identification information memory 21 and the inspection processing section 23 are parts to be realized by a program or the like installed in a computer for controlling the inspection device.

With the above-described configuration, the inspection device obtains the identification information of the printed matter according to the identification image attached to the printed matter, and inspects according to the identification information.

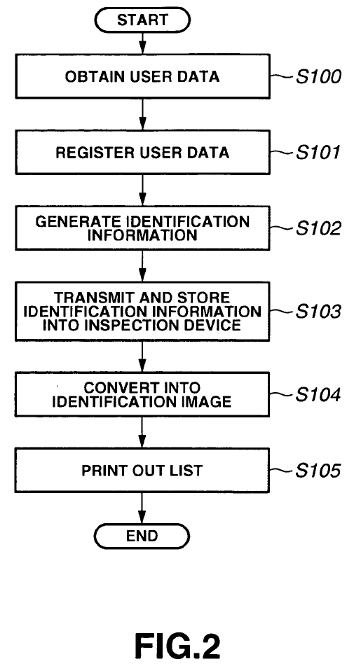

FIG. 2 is a flow chart showing an example of a processing flow when user data is registered in an image forming device and a list is printed out.

First, the image forming device 10 obtains user data (step 100), registers the user data into the user data registration section 11 (step 101), and generates identification information for each printed matter by the identification information generation section 12 (step 102).

Then, the identification information is transmitted to the inspection device 20 to store the identification information into the identification information memory 21 (step 103), and the identification information is converted into an identification image by the identification information conversion section 13 (step 104). And then, a list of user data that associates the information indicating each printed matter with the identification image of the printed matters is generated by the list printing section 14, and is printed out by the image forming section (step 105).

In FIG. 2, the registration of the user data and the printing of the list are performed continuously, but the list may be printed out by a procedure that the identification information is transmitted to the inspection device in step 103, and a list printout instruction is waited before steps 102, 104, 105 are performed.

In a case where the inspection using the list is performed and it is not necessary to store the identification information into the inspection device, step 103 may be omitted, and the list can be printed out without storing the identification information into the inspection device 20.

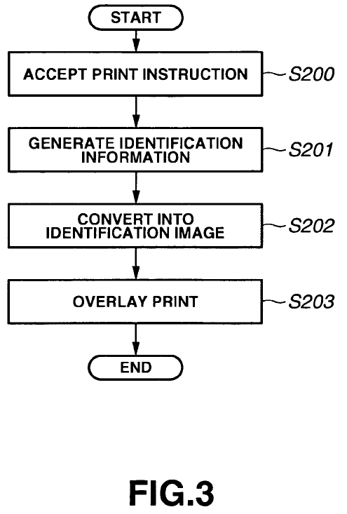

FIG. 3 is a flow chart showing an example of a processing flow when a printed matter is printed out.

First, the image forming device 10 receives a printed matter print-out instruction (step 200), obtains user data from the user data registration section 11 to generate identification information for each printed matter by the identification information generation section 12 (step 201), and converts the identification information into an identification image by the identification information conversion section 13 (step 202).

Then, the user data is obtained from the user data registration section 11 by the variable printing section 16, and the form associated with the user data is obtained from the form registration section 15, the user data and the form are overlaid, and the identification image is added to a prescribed portion to perform overlay printing (step 203).

The identification image may be printed out to anything other than the printed matter itself, such that the printed matter is configured, for example, to include a printed matter itself and an inspection sheet to print out the identification image on the inspection sheet.

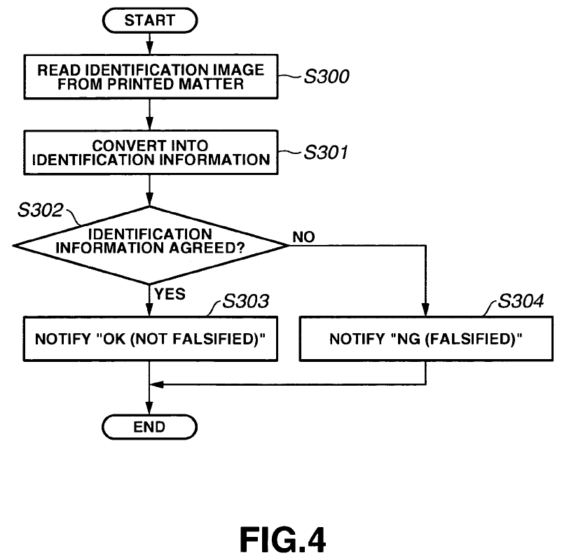

FIG. 4 is a flow chart showing an example of a processing flow when a printed matter is inspected using identification information stored in an inspection device.

First, an identification image is read from the printed matter by the identification image read section 22 (step 300), the identification image is converted into identification information by the inspection processing section 23 (step 301), and it is judged whether or not the identification information on the printed matter agrees with the identification information stored in the identification information memory 21 (step 302).

And, when it is judged that both of the identification information agree with each other (YES in step 302), “OK (not falsified)” is notified as the inspected result (step 303).

Meanwhile, when it is judged that both of the identification information do not agree (NO in step 302), “NG (falsified)” is notified as the inspected result (step 304).

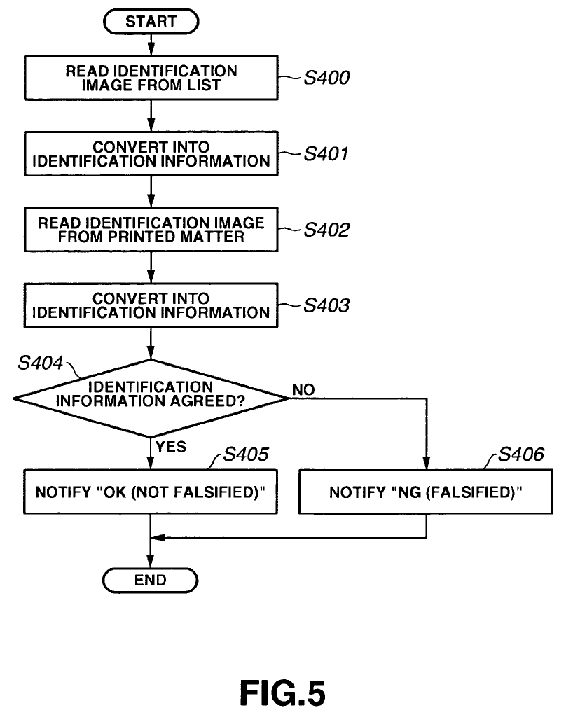

FIG. 5 is a flow chart showing an example of a processing flow when a printed matter is inspected using identification information described in a list.

First, an identification image associated with information indicating a printed matter to be inspected is read from the list by the identification image read section 22 (step 400), and the identification image is converted into identification information by the inspection processing section 23 (step 401).

Then, the identification image attached to the printed matter is read by the identification image read section 22 (step 402), and the identification image is converted into identification information by the inspection processing section 23 (step 403).

The identification information obtained from the identification image in the list is compared with the identification information obtained from the identification image of the printed matter (step 404), and if it is judged that both of the identification information agree with each other (YES in step 404), “OK (not falsified)” is notified as the inspected result (step 405).

Meanwhile, if it is judged that they do not agree with each other (NO in step 404), “NO (falsified)” is notified as the inspected result (step 406).

In FIG. 5, the identification image is read from the printed matter after the identification image is read from the list. An order of reading the identification image has no connection with the inspection, and it may be configured, for example, to read the identification image from the list after the identification image is read from the printed matter.

FIG. 1 shows that the image forming device and the inspection device are used to configure the printed matter inspection system. However, the printed matter inspection system may be configured to include a single device, for example, by disposing each of the part configuring the inspection device to the image forming device.

Although the printed matter inspection system described with reference to FIG. 1 and FIG. 2 transmits the identification information generated by the image forming device to the inspection device, it is also possible to generate identification information by obtaining the user data by the inspection device. Details will be described with reference to an exemplary embodiment.

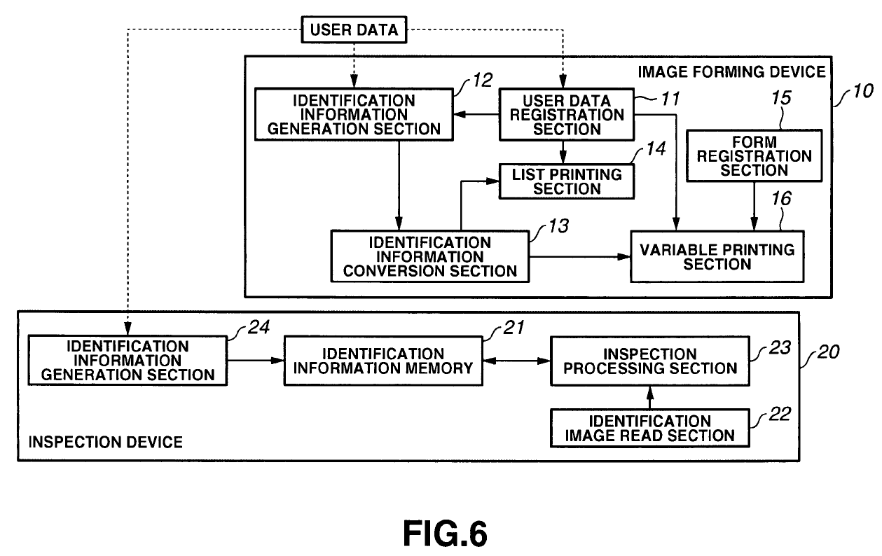

FIG. 6 is a functional block diagram showing an example of a structure of a printed matter inspection system of this exemplary embodiment. For parts of which functions are the same manner as those of FIG. 1, the same reference numerals as those used in FIG. 1 are denoted, and detailed descriptions thereof will be omitted.

As shown in FIG. 6, the printed matter inspection system is provided with the image forming device 10 and the inspection device 20, which are connected by means of an unshown arbitrary connection unit.

The image forming device 10 is provided with the user data registration section 11, the identification information generation section 12, the identification information conversion section 13, the list printing section 14, the form registration section 15 and the variable printing section 16.

The user data registration section 11, the identification information generation section 12, the identification information conversion section 13, the list printing section 14, the form registration section 15 and the variable printing section 16 are parts which are realized by a program or the like installed in a computer for controlling the image forming device.

The image forming device generates identification information based on user data and also converts the identification information into a printable identification image. And, a list having information indicating the printed matter and an identification image of the printed matter, both of which are associated with each other, is printed out. When an instruction to print out the printed matter is given, the user data is overlaid on a prescribed portion of the form, and the identification image is added to generate print data. Then, the printed matter with the identification image added is printed out.

The inspection device 20 is provided with the identification information memory 21, the identification image read section 22, the inspection processing section 23, and an identification information generation section 24.

The identification information generation section 24 generates identification information which can be used to judge that the user data is falsified for each printed matter. Specifically, for example, a hash value is calculated based on the user data, and is used as the identification information.

The identification information memory 21, the inspection processing section 23, and the identification information generation section 24 are parts realized by a program or the like installed in a computer for controlling the inspection device.

Obtaining the user data, the inspection device generates identification information based on the user data, stores it, and inspects by comparing with the identification information obtained based on the identification image added to the printed matter.

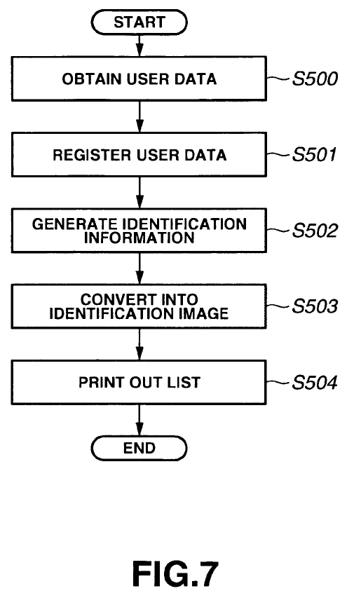

FIG. 7 is a flow chart showing an example of a processing flow, when user data is registered into an image forming device and a list is printed out.

First, the image forming device 10 obtains user data (step 500), registers the user data into the user data registration section 11 (step 501), and generates the identification information for each printed matter by the identification information generation section 12 (step 502).

Then, the identification information is converted into an identification image by the identification information conversion section 13 (step 503), and a list of the user data having information indicating the individual printed matters and the identification images of the printed matters, both of which are mutually associated with each other is generated by the list printing section 14 and is printed out by the image forming section (step 504).

The image forming device 10 may be configured so that after the user data is registered in step 501, the processing is stopped temporarily to wait for a list printing instruction, and then step 502 and following steps are executed.

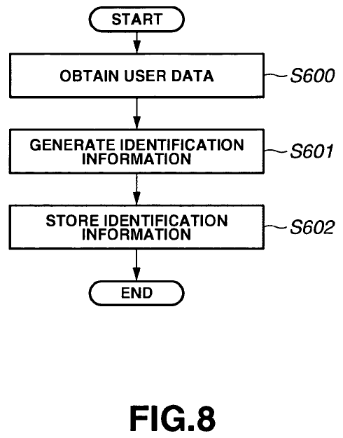

FIG. 8 is a flow chart showing an example of a processing flow when identification information is stored in an inspection device.

First, the inspection device 20 obtains user data (step 600), generates the identification information for each printed matter by the identification information generation section 24 (step 601), and stores the identification information in the identification information memory 21 (step 602).

Thus, the identification information is generated by the inspection device in this exemplary embodiment, so that the inspection device can inspect the printed matter without being connected to the image forming device.

Those who order the printing can check whether or not falsification has been made by providing them with the user data via a network or a medium.

Besides, in a case where those who order printing generate the user data, they can check easily and quickly whether or not a desired printed matter has been generated by using the user data which is under their management.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printed matter inspection system, comprising:
an image forming device including;
a first identification information generation section that generates identification information for each printed matter based on user data,
an identification information conversion section that converts the identification information into a printable identification image,
a variable printing section that performs variable printing of the printed matter to which the identification image is added, using the user data, and
a list printing section that prints out a list having the user data and the identification information both of which are associated with each other, and
an inspection device including;
an identification image read section that reads the identification image, and
an inspection processing section that converts the identification image into identification information to inspect a printed matter.

2. A printed matter inspection system, comprising:
an image forming device including;
a first identification information generation section that generates identification information for each printed matter based on user data,
an identification information conversion section that converts the identification information into a printable identification image,
a variable printing section that performs variable printing of the printed matter to which the identification image is added, using the user data, and
an inspection device including;
an identification information memory that stores the identification information,
an identification image read section that reads the identification image which is added to a printed matter, and
an inspection processing section that converts the read identification image into identification information to inspect the printed matter, based on the converted identification information and the identification information stored in the identification information memory.

3. The printed matter inspection system according to claim 2, wherein:
the image forming device further comprises a list printing section that prints out a list having the user data and the identification information both of which are associated with each other, and
the inspection processing section inspects the printed matter based on the identification information converted from the identification image read from the list or the identification information stored in the identification information memory.

4. A printed matter inspection system, comprising:
an image forming device including;
a first identification information generation section that generates identification information for each printed matter based on user data,
an identification information conversion section that converts the identification information into a printable identification image, and
a variable printing section that performs variable printing of the printed matter to which the identification image is added, using the user data, and
an inspection device including;
a second identification information generation section that generates identification information for each printed matter based on the user data,
an identification image read section that reads the identification image added to a printed matter, and
an inspection processing section that converts the read identification image into identification information to inspect the printed matter, based on the converted identification information and the identification information generated by the second identification information generation section.

5. The printed matter inspection system according to claim 4, wherein:
the image forming device further comprises a list printing section that prints out a list in which the user data and the identification information are associated with each other, and
the inspection processing section inspects the printed matter based on the identification information converted from the identification image read from the list or the identification information generated by the second identification information generation section.

6. The printed matter inspection system according to claim 1, wherein:
when the printed matter is printed out, the first identification information generation section regenerates the identification information, and
the variable printing section performs the printing of the printed matter adding the regenerated identification image.

7. A print inspection device, comprising:
an identification information generation section that generates identification information for each printed matter based on user data,
an identification information conversion section that converts the identification information into a printable identification image,
a variable printing section that performs variable printing of the printed matter to which the identification image is added, using the user data,
a list printing section that prints out a list in which the user data and the identification information are associated with each other,
an identification image read section that reads the identification image, and
an inspection processing section that converts the identification image into identification information to inspect a printed matter.

8. A print inspection device, comprising:
an identification information generation section that generates identification information for each printed matter based on user data,
an identification information conversion section that converts the identification information into a printable identification image,
a variable printing section that performs variable printing of the printed matter to which the identification image is added, using the user data,
an identification information memory that stores the identification information,
an identification image read section that reads an identification image added to a printed matter, and
an inspection processing section that converts the read identification image into identification information to inspect the printed matter, based on the converted identification information and the identification information stored in the identification information memory.

9. The print inspection device according to claim 8, further comprising:
a list printing section that prints out a list having the user data and the identification information both of which are associated with each other, wherein:
the inspection processing section inspects the printed matter based on the identification information converted from the identification image read from the list, or the identification information stored in the identification information memory.

10. The print inspection device according to claim 7, wherein:
when the printed matter is printed out, the identification information generation section regenerates the identification information, and
the variable printing section performs the printing of the printed matter adding the regenerated identification image.

11. An image forming device, comprising:
an identification information generation section that generates identification information for each printed matter based on user data,
an identification information conversion section that converts the identification information into a printable identification image, and
a variable printing section that performs variable printing of the printed matter to which the identification image is added, using the user data.

12. The image forming device according to claim 11, further comprising:
a list printing section that prints out a list having the user data and the identification information both of which are associated with each other.

13. The image forming device according to claim 11, wherein the identification information generation section sends the identification information to an inspection device that inspects the printed matter.

14. The image forming device according to claim 11, wherein:
when the printed matter is printed out, the identification information generation section regenerates the identification information, and
the variable printing section performs the printing of the printed matter, adding the regenerated identification image.

15. An inspection device, comprising:
an identification information memory that stores identification information generated, based on user data, for each printed matter by an image forming device,
an identification image read section that reads an identification image in which the identification information is converted into an image, and
an inspection processing section that converts the read identification image into identification information to inspect based on the identification information stored in the identification information memory.

16. An inspection device, comprising:
an identification information generation section that generates identification information for each printed matter based on user data,
an identification image read section that reads an identification image which is converted from the identification information and added to a printed matter, and
an inspection processing section that converts the read identification image into identification information to inspect the printed matter, based on the converted identification information and the identification information generated by the identification information generation section.

17. A computer readable recording medium storing a program causing a computer to execute a process for a print inspection, the process comprising:
generating identification information for each printed matter based on user data,
converting the identification information into a printable identification image,
performing variable printing of the printed matter to which the identification image is added by using the user data,
printing out a list having the user data and the identification information both of which are associated with each other,
reading an identification image, and
inspecting a printed matter by converting the read identification image into identification information.

18. A computer readable recording medium storing a program causing a computer to execute a process for a print inspection, the process comprising:
generating identification information for each printed matter based on user data,
converting the identification information into a printable identification image,
performing variable printing of the printed matter to which the identification image is added by using the user data,
storing the identification information,
reading an identification image which is added to a printed matter,
converting the read identification image into the identification information, and
inspecting the printed matter, based on the converted identification information and the stored identification information.

19. The computer readable recording medium storing a program according to claim 18, the process further comprising:
printing out a list having the user data and the identification information both of which are associated with each other, and
inspecting the printed matter based on the identification information obtained by converting the identification image read from the list or the stored identification information.

20. The computer readable recording medium storing a program according to claim 17, the process further comprising:
when the printed matter is printed out, regenerating the identification information; and
printing the printed matter, adding the regenerated identification image.

21. A computer readable recording medium storing a program causing a computer to execute a process for an image formation, the process comprising:
generating identification information for each printed matter based on user data,
converting the identification information into a printable identification image, and
performing variable printing of the printed matter to which the identification image is added by using the user data.

22. The computer readable recording medium storing a program according to claim 21, the process further comprising:
printing out a list having the user data and the identification information both of which are associated with each other.

23. The computer readable recording medium storing a program according to claim 21, wherein:
the identification information is sent to an inspection device for inspecting the printed matter.

24. The computer readable recording medium storing a program according to claim 21, wherein:
when the printed matter is printed out, the identification information is regenerated, and
the printing of the printed matter is executed by using the regenerated identification image.

25. A computer readable recording medium storing a program causing a computer to execute a process for inspecting, the process comprising:
storing identification information generated for each printed matter based on user data,
reading an identification image in which the identification information is converted into an image, and
inspecting, using the stored identification information, by converting the read identification image into identification information.

26. A computer readable recording medium storing a program causing a computer to execute a process for inspecting, the process comprising:
generating identification information for each printed matter based on user data, and
reading an identification image in which the identification information is converted into an image, and
inspecting the printed matter, using identification information obtained by converting the read identification image.
